(19) United States
(12) Patent Application Publication
(10) Pub. No.: US 2023/0403770 A1
(43) Pub. Date: Dec. 14, 2023

(54) COOKING DEVICE

(71) Applicant: SAMSUNG ELECTRONICS CO., LTD., Suwon-si (KR)

(72) Inventors: Geunyong PARK, Suwon-si (KR); Sangjin JEONG, Suwon-si (KR); Keunseuk OH, Suwon-si (KR); Pungyeun CHO, Suwon-si (KR)

(73) Assignee: SAMSUNG ELECTRONICS CO., LTD., Suwon-si (KR)

(21) Appl. No.: 18/238,787

(22) Filed: Aug. 28, 2023

Related U.S. Application Data
(63) Continuation of application No. PCT/KR2022/005394, filed on Apr. 14, 2022.

(30) Foreign Application Priority Data
Apr. 28, 2021 (KR) 10-2021-0055266

(51) Int. Cl. H05B 6/76; H05B 6/64; H05B 6/68

(52) U.S. Cl. CPC H05B 6/763; H05B 6/6414; H05B 6/687

(57) ABSTRACT

A cooking apparatus including a main body, a cooking chamber inside the main body, and a door in front of the main body and configured to be rotatable to open and close the cooking chamber. The door includes door frame, a rear frame coupled to a rear of the door frame and configured to prevent leakage of electromagnetic waves from inside the cooking chamber through the door, an exterior panel coupled to a front of the door frame, and a grounding member integrally formed with the exterior panel. The grounding member includes a first grounding part extending rearward, a second grounding part bent from the first grounding part at a bending position and in contact with the rear frame so that the exterior panel is grounded to the rear frame, and bending guide grooves between the first grounding part and the second grounding part at the bending position.

### CROSS-REFERENCE TO RELATED APPLICATIONS

This application is a continuation of International Application PCT/KR2022/005394, filed Apr. 14, 2022, and claims foreign priority to Korean Application 10-2021-0055266, filed Apr. 28, 2021, the disclosures of which are incorporated herein by reference in their entireties.

### BACKGROUND

### 1. Field

The present disclosure relates to a cooking apparatus, and more particularly, to a cooking apparatus including a grounding member having an improved structure.

### 2. Description of Related Art

A cooking apparatus is an apparatus for heating and cooking a cooking object such as food, and refers to an apparatus capable of providing various functions related to cooking, such as heating, thawing, drying and sterilization of the cooking object.

Such a cooking apparatus includes, for example, an oven such as a gas oven and an electric oven, a microwave heating device (hereinafter referred to as a microwave), a gas range, an electric range, a gas grill, an electric grill, and the like.

In general, the oven is an apparatus that cooks food by directly transferring heat to the food or heating the inside of a cooking chamber through a heat source for generating heat such as a heater, and the microwave is an apparatus that cooks food by frictional heat between molecules generated by disturbing a molecular arrangement of food using high frequency waves as a heating source.

In this case, a frame for preventing leakage of electromagnetic waves may be provided at the rear of a door of the cooking apparatus so that the electromagnetic waves generated inside the cooking chamber do not leak to the outside.

In addition, for an aesthetic appearance of the door of the cooking apparatus, an exterior panel made of metal may be attached to a front surface of the door. Accordingly, grounding may be required between the exterior panel in front of the door and the frame for preventing leakage of electromagnetic waves at the rear of the door.

However, when a grounding member for grounding is separately formed and inserted into the door of the cooking apparatus, in a case where the assembly is missed in an assembly line, it may greatly affect quality of the entire cooking apparatus.

Furthermore, a production cost increases as a separate component for grounding is used.

### SUMMARY

According to an embodiment of the present disclosure, a cooking apparatus may include a main body, a cooking chamber inside the main body, a door in front of the main body and configured to be rotatable to open and close the cooking chamber, the door including a door frame, a rear frame coupled to a rear of the door frame and configured to prevent leakage of electromagnetic waves from inside the cooking chamber through the door, an exterior panel coupled to a front of the door frame, and a grounding member integrally formed with the exterior panel and including a first grounding part extending rearward, a second grounding part bent from the first grounding part at a bending position and in contact with the rear frame so that the exterior panel is grounded to the rear frame, and bending guide grooves between the first grounding part and the second grounding part at the bending position.

According to an embodiment of the disclosure, the exterior panel may include a panel body, and grounding member may further include an extension part extending parallel to the exterior panel from the panel body.

According to an embodiment of the disclosure, a side of the extension part may be spaced apart from the exterior panel.

According to an embodiment of the disclosure, an extension length of the extension part may be longer than a thickness of the exterior panel.

According to an embodiment of the disclosure, the first grounding part may extend rearward from the extension part and penetrate the door frame.

According to an embodiment of the disclosure, the grounding member may further include a first bent portion, and a second bent portion, where the extension part and the first grounding part are connected at the first bent portion, and the first grounding part and the second grounding part are connected at the second bent portion.

According to an embodiment of the disclosure, the bending guide grooves may be formed to be symmetrically with respect to the second bent part.

According to an embodiment of the disclosure, a width of the second bent part may be smaller than widths of the first grounding part and the second grounding part.

According to an embodiment of the disclosure, the cooking apparatus may further include a handle that is grippable and is at a front of the exterior panel, wherein the handle may include a protrusion extending rearward.

According to an embodiment of the disclosure, the exterior panel may include a handle coupling part through which the protrusion penetrates.

According to an embodiment of the disclosure, the door frame may include a handle insertion portion that is recessed so that the protrusion penetrated through the handle coupling part is inserted into the handle insertion portion, and a grounding member passing hole, wherein the grounding member may pass through the grounding member passing hole.

According to an embodiment of the disclosure, the exterior panel may include a panel body, and the grounding member may further include an extension part extending from the panel body toward the handle coupling part.

According to an embodiment of the disclosure, the handle may be mounted on the exterior panel, and the extension part may be covered by the handle.

According to an embodiment of the disclosure, the first grounding part may extend rearward from the extension part and pass through the grounding member passing hole, and the second grounding part may be disposed between the rear frame and the door frame.

According to an embodiment of the disclosure, the first grounding part may be on a side of the handle insertion part, and the second grounding part may be on a rear of the handle insertion part.

According to an embodiment of the present disclosure, a cooking apparatus may include a main body; a cooking chamber inside the main body; door including a door frame, a rear frame, an exterior panel, and a grounding member integrally formed with the exterior panel and including a first grounding part, a second grounding part, and bending guide grooves at a bending position between the first grounding part and the second grounding part and configured so that the second grounding part is bendable from the first grounding part at the bending position, wherein (a) the door frame, the rear frame, the exterior panel, and the grounding member may be configured so that the rear frame is couplable to a rear of the door frame, the exterior panel is couplable to a front of the door frame with the first grounding part extending rearward and the second grounding part being bendable from the first grounding part at the bending position to be in contact the rear frame so that the exterior panel is grounded to the rear frame, to thereby provide the door in an assembled state configured to open and close the cooking chamber, and (b) with the door in the assembled state configured to open and close the cooking chamber, the rear frame is configured to prevent leakage of electromagnetic waves from inside the cooking chamber through the door.

According to an embodiment of the disclosure, a cooking apparatus may include a main body, a cooking chamber formed inside the main body, and a door provided to open and close the cooking chamber, wherein the door includes a door frame provided in front of the main body to be rotatable with respect to the cooking chamber, a rear frame coupled to the rear of the door frame to prevent leakage of electromagnetic waves, an exterior panel provided to cover the door frame in the front of the door frame and including a panel body, and a grounding member integrally formed with the exterior panel to be bent toward the door frame, the grounding member including a grounding part provided to be in contact with the door frame and the rear frame, and a bent part having a width smaller than a width of the grounding part.

According to an embodiment of the disclosure, the grounding member may further include bending guide grooves formed to be cut out from opposite sides of the bent part.

According to an embodiment of the disclosure, the grounding member may further include an extension part having one side connected to the panel body of the exterior panel and the other side connected to the grounding part, and the extension part may extend parallel to the exterior panel so that a side thereof is spaced apart from the exterior panel.

According to an embodiment of the disclosure, a cooking apparatus may include a main body, a cooking chamber formed inside the main body, a door frame provided in front of the main body to be rotatable with respect to the cooking chamber, a rear frame coupled to the rear of the door frame to prevent leakage of electromagnetic waves, an exterior panel provided to cover the door frame in the front of the door frame and including a panel body, and a grounding member integrally formed with the exterior panel to be in contact with the rear frame, the grounding member including an extension part extending parallel to the exterior panel from the panel body so that a side thereof is spaced apart from the exterior panel, a grounding part connected to the extension part to extend toward the rear of the exterior panel, and a bending guide groove formed to be cut out at a bending position of the grounding part.

According to an embodiment of the disclosure, a pair of the bending guide grooves may be provided to guide the bending position of the grounding part and may be cut out from the outside to the inside of the grounding member.

### BRIEF DESCRIPTION OF THE DRAWINGS

FIG. 1 is a perspective view of a cooking apparatus according to an embodiment of the present disclosure.

FIG. 2 is an internal front view of the cooking apparatus according to an embodiment of the present disclosure.

FIG. 3 is an exploded perspective view of a handle, a door, and a control unit of the cooking apparatus according to an embodiment of the present disclosure.

FIG. 4 is a rear perspective view of an exterior panel in FIG. 3.

FIG. 5 is an enlarged view of part A in FIG. 4.

FIG. 6 is a view illustrating a state in which a grounding member in FIG. 5 is bent.

FIG. 7 is a front enlarged view of the grounding member of the exterior panel in FIG. 3.

FIG. 8 is a cross-sectional view of a state in which a handle is coupled to the door of the cooking apparatus according to an embodiment of the present disclosure.

FIG. 9 is an enlarged view of part B in FIG. 8.

### DETAILED DESCRIPTION

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, components, parts, or combinations thereof described in the specification, and do not exclude the presence or addition of one or more other features, numbers, steps, operations, components, parts, or combinations thereof.

It will be understood that, although the terms first, second, etc. may be used herein to describe various components, these components should not be limited by these terms, and these terms are only used to distinguish one component from another. For example, without departing from the scope of the present disclosure, the first component may be referred to as a second component, and similarly, the second component may also be referred to as a first component. The term “and/or” includes any combination of a plurality of related items or any one of a plurality of related items.

Various embodiments of the present disclosure are directed to providing a cooking apparatus in which an exterior panel of a door and a grounding member are integrally formed.

Moreover, various embodiments of the present disclosure are directed to providing a cooking apparatus capable of accurately guiding a bending position of a grounding member.

In addition, various embodiments of the present disclosure are directed to providing a cooking apparatus capable of minimizing irregularities formed on an exterior panel by an external force applied to a grounding member.

According to various embodiments of the present disclosure, by forming a bending guide groove in a grounding member and bending the grounding member in an accurate position, accuracy of assembly can be secured.

Moreover, according to various embodiments of the present disclosure, by extending an extension part of a grounding member extending from a panel body of an exterior panel by a predetermined length, formation of irregularities on the exterior panel caused by an external force being applied to the grounding member can be minimized.

Hereinafter, an embodiment of the present disclosure will be described in detail with reference to the accompanying drawings.

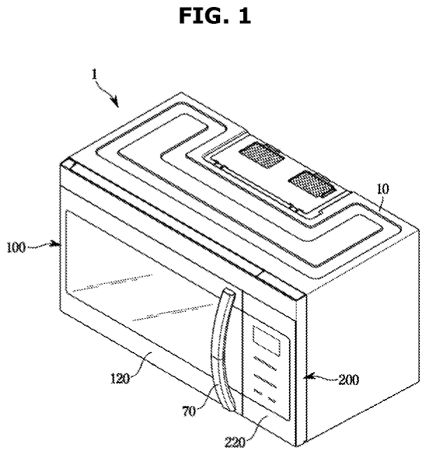

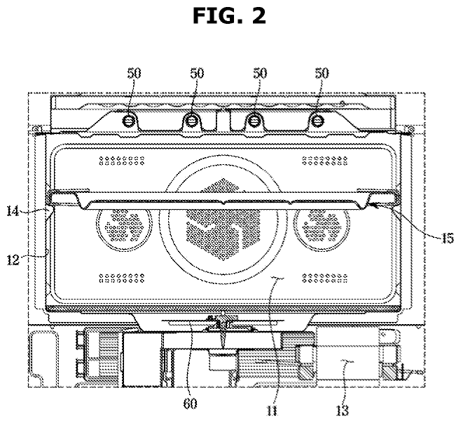

FIG. 1 is a perspective view of a cooking apparatus according to an embodiment of the present disclosure. FIG. 2 is an internal front view of the cooking apparatus according to an embodiment of the present disclosure.

Referring to FIGS. 1 and 2, a cooking apparatus 1 may include a main body 10 forming an outer appearance.

The cooking apparatus 1 may include a door 100 provided to open and close a cooking chamber 11. The door 100 may be rotatably provided with respect to the main body 10 to open and close the cooking chamber 11.

The cooking apparatus 1 may include a handle 70 mounted on the door 100 to be gripped.

The cooking apparatus 1 may include a control unit 200 provided to be operable by a user.

Both the door 100 and the control unit may be mounted on the front of the main body 10. The control unit may include a control panel 210 to receive a command of the user. A shape of the control panel 210 may not be limited to that illustrated in FIG. 1.

Referring to FIG. 2, the cooking chamber 11 may be provided in a substantially rectangular parallelepiped shape having a long side.

A cabinet 12 may be provided inside the main body 10 to form the cooking chamber 11. A predetermined separation space may be formed between the main body 10 and the cabinet 12.

The main body 10 and the cabinet 12 may be provided to open in a forward direction of the cooking apparatus 1. The user may place a cooking object inside the cooking chamber 11 through the open part.

The cooking apparatus 1 may include a machine room 13 provided below the cooking chamber 11. Various electronic components for driving the cooking apparatus 1 may be disposed inside the machine room 13.

The cooking apparatus 1 may include a shelf 15 installed inside the cooking chamber 11 so that the user may place the cooking object thereon. The shelf 15 may be detachably disposed inside the cooking chamber 11.

The cooking chamber 11 may include supports 14 formed on opposite sides of the cooking chamber 11 so that the shelf 15 is fixedly mounted between upper and lower surfaces of the cooking chamber 11.

More specifically, the support 14 may protrude into the cabinet 12. However, a shape of the support 14 is not limited thereto and may be provided in a form in which a structure such as a separate bracket is coupled to the cabinet 12.

The cooking apparatus 1 may include a first heating source 50 and a second heating source 60. The first heating source 50 and the second heating source 60 may be provided to supply heat to the cooking object placed on the shelf 15.

The cooking object may be placed on the lower surface of the cooking chamber 11 without the shelf 15, and in this case, the first heating source 50 and the second heating source 60 may also supply heat to the cooking object placed on the lower surface of the cooking chamber 11.

The first heating source 50 may include a plurality of heaters for generating radiant heat. The plurality of heaters may be provided to directly transfer heat to the cooking object by radiating heat generated therefrom.

The second heating source 60 may include a magnetron for generating high frequency waves. The high frequency waves generated from the magnetron may be irradiated into the inside of the cooking object to cook the inside of the cooking object by frictional heat between molecules generated by repeatedly changing a molecular arrangement of moisture contained in the cooking object.

The second heating source 60 may be disposed in the machine room 13. The second heating source 60 may oscillate high frequency waves from the machine room 13 toward the lower surface of the cooking chamber 11, and the high frequency waves may be irradiated to the shelf 15 or the cooking object by passing through the lower surface of the cooking chamber 11.

However, the configuration of the heating source of the cooking apparatus 1 according to an embodiment of the present disclosure is not limited thereto and may be provided to include only one of the first heating source 50 and the second heating source 60.

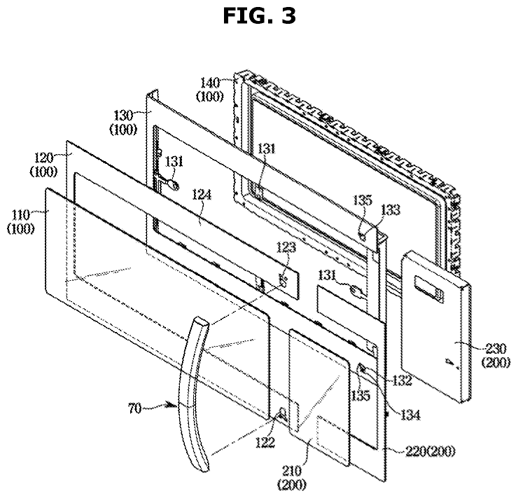

FIG. 3 is an exploded perspective view of a handle, a door, and a control unit of the cooking apparatus according to an embodiment of the present disclosure.

Referring to FIG. 3, the cooking apparatus 1 may include the handle 70, the door 100 and the control unit 200.

The door 100 may include a transparent member 110.

The transparent member 110 may be provided such that the user may observe the inside of the cooking chamber 11 when the door 100 closes the cooking chamber 11.

The transparent member 110 may be provided to include a plastic or glass material, but is not limited thereto.

The door 100 may include an exterior panel 120 and a door frame 130.

The exterior panel 120 may be mounted on the front of the door frame 130. More specifically, the exterior panel 120 may be adhered to the door frame 130 by an inlay method.

For example, the exterior panel 120 may be coated on the door frame 130 using heat and pressure after applying colors and letters to a sheet-type film using a silk screen technique.

Through this, the exterior panel 120 may cover the front of the door frame 130 to enhance the aesthetics of the cooking apparatus 1.

That is, the exterior panel 120 may be provided to serve as a kind of decorative panel.

The exterior panel 120 may include a grounding member 300. The grounding member 300 may be grounded to a rear frame 140, which will be described later, by passing through the door frame 130. Details thereof will be described later.

The door frame 130 may be provided in a substantially rectangular ring shape with an open central part.

The door frame 130 may include a plurality of seating parts 131 extending from edges of the door frame 130 toward the center. The transparent member 110 may be seated and supported on the plurality of seating parts 131.

The door frame 130 may include a first handle insertion part 132 and a second handle insertion part 133.

The first handle insertion part 132 may be formed at a lower part of the door frame 130. The second handle insertion part 133 may be formed at an upper part of the door frame 130.

The first handle insertion part 132 and the second handle insertion part 133 may be recessed toward the rear of the door frame 130.

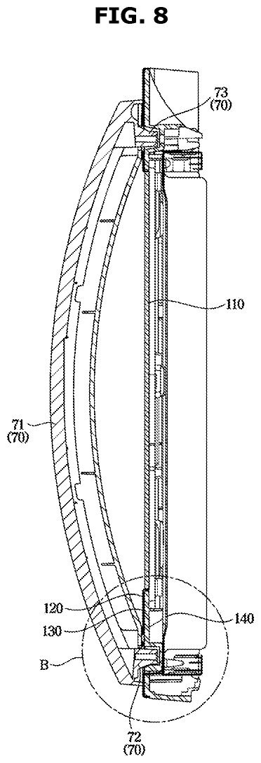

A first protrusion 72 (see FIG. 8) and a second protrusion 73 (see FIG. 8) of the handle 70, which will be described later, are the first handle insertion part 132 and the second handle insertion part 133 of the door frame 130, respectively. Details thereof will be described later.

The door frame 130 may include a grounding member passing hole 134. The grounding member 300 bent from the exterior panel 120 may be provided to pass through the grounding member passing hole 134 of the door frame 130.

The grounding member passing hole 134 may be provided below the first handle insertion part 132. The grounding member passing hole 134 may be formed by cutting the door frame 130.

However, the position of the grounding member passing hole 134 may be changed together depending on the formation position of the grounding member 300.

The door frame 130 may include a guide protrusion 135. The guide protrusion 135 may be formed to protrude forward from a front surface of the door frame 130.

The guide protrusion 135 may be disposed to be biased to one side with respect to an extending direction of the handle 70. A guide insertion part (not shown) may be formed on the handle 70 so that the guide protrusion 135 is inserted therein.

Therefore, when the handle 70 is erroneously assembled by turning upside down, the handle 70 may not be coupled to the exterior panel 120 and the door frame 130 by the guide protrusion 135. Through this, erroneous assembly of the handle 70 in a vertical direction may be prevented.

A plurality of the guide protrusions 135 may be formed to be provided adjacent to the first handle insertion part 132 and the second handle insertion part 133 of the door frame 130. However, the present disclosure is not limited thereto, and the single guide protrusion 135 may be provided.

The door 100 may include the rear frame 140.

The rear frame 140 may be coupled to the rear of the door frame 130. A plurality of choke structures may be formed on an edge of the rear frame 140 to prevent leakage of electromagnetic waves inside the cooking chamber 11 to the outside.

The rear frame 140, which is a part to which the grounding member 300 described above is grounded, is provided to be in contact with the grounding member 300 of the exterior panel 120. Details thereof will be described later.

The control unit 200 may include the control panel 210, a control exterior panel 220 and a support frame 230.

A command of the user may be input to the cooking apparatus 1 through the control panel 210. The control panel 210 may be provided as a touch type or pressure sensitive type. However, the present disclosure is not limited thereto and may be provided in various types.

The control exterior panel 220 may be placed on the same plane as the exterior panel 120 of the door 100. The control exterior panel 220 may also be adhered to the support frame 230 using the same inlay method as the exterior panel 120 of the door 100.

The handle 70 may include a handle case 71, the first protrusion 72 (see FIG. 8) and the second protrusion 73 (see FIG. 8). The handle 70 may be coupled to the front of the door 100.

More specifically, the handle 70 may be coupled to the door frame 130 and the rear frame 140 by a separate fastening member by penetrating the exterior panel 120. The fastening member may not be exposed to the user by being fastened at the rear of the door 100.

In addition to the configuration of the door 100 described with reference to FIG. 3, a separate shielding member or fixing frame may be provided.

Through this, an impact of the door 100 caused by flying a fragment of the cooking object inside the cooking chamber 11 may be prevented. The shielding member may be provided to manage the door 100 more hygienically.

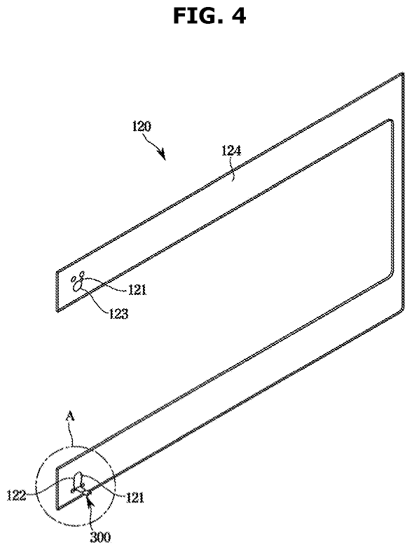

FIG. 4 is a rear perspective view of an exterior panel in FIG. 3.

Referring to FIG. 4, the exterior panel 120 may include a panel body 124.

The panel body 124 is a body part of the exterior panel 120 and may be provided in a substantially ‘C’ shape.

The exterior panel 120 may include a first handle coupling part 122 and a second handle coupling part 123.

The first handle coupling part 122 may be formed to be cut out on an upper side of the panel body 124. The first protrusion 72 of the handle 70, which will be described later, may be inserted into the door frame 130 by penetrating through the first handle coupling part 122.

The second handle coupling part 123 may be formed to be cut out on a lower side of the panel body 124. The second protrusion 73 of the handle 70, which will be described later, may be inserted into the door frame 130 by penetrating through the second handle coupling part 123.

The exterior panel 120 may include protrusion passing parts 121.

The protruding passing parts 121 may be formed to be cut out on the panel body 124 to communicate with the first handle coupling part 122 and the second handle coupling part 123, respectively.

The guide protrusions 135 of the door frame 130 may be inserted into the handle 70 by penetrating through the exterior panel 120 through the protrusion passing parts 121.

The protrusion passing parts 121 may be provided to have the number corresponding to the number of guide protrusions 135.

Although the cooking apparatus 1 according to an embodiment of the present disclosure is illustrated and described as having a plurality of the protrusions passing parts 121, the present disclosure is not limited thereto, and when the single guide protrusion 135 is provided, the protrusion passing part 121 may also be formed to be adjacent to either the first handle coupling part 122 or the second handle coupling part 123.

In addition, the protruding passing part 121 does not necessarily need to communicate with the first handle coupling part 122 or the second handle coupling part 123, and may be formed at any position as long as the guide protrusion 135 may penetrate therethrough.

The exterior panel 120 may include the grounding member 300.

The grounding member 300 may be formed to be bent toward the rear of the exterior panel 120. More specifically, the rear of the exterior panel 120 refers to a direction of directing to the door frame 130 or the rear frame 140 from the exterior panel 120. Details related to the grounding member 300 will be described later.

FIG. 4 illustrates that the grounding member 300 is formed inside the first handle coupling part 122 of the exterior panel 120, but the position of the grounding member 300 is not limited thereto.

For example, the grounding member 300 may be formed inside the second handle coupling part 123 of the exterior panel 120 to be bent toward the rear of the exterior panel 120.

The grounding member 300 may also be integrally formed with the control exterior panel 220 of the control unit 200.

Therefore, the grounding member 300 may be formed at any position as long as the grounding member 300 may be grounded to the rear frame 140.

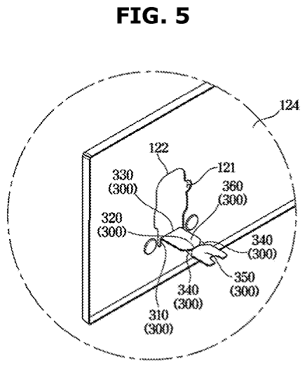

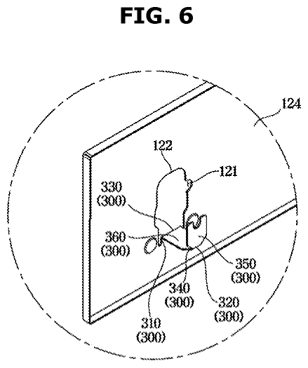

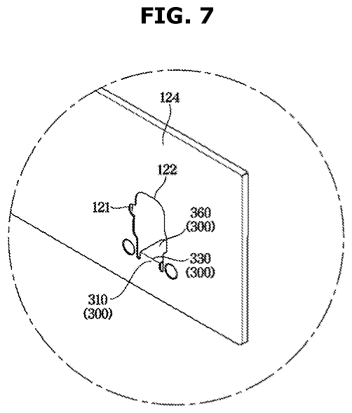

FIG. 5 is an enlarged view of part A in FIG. 4. FIG. 6 is a view illustrating a state in which a grounding member in FIG. 5 is bent. FIG. 7 is a front enlarged view of the grounding member of the exterior panel in FIG. 3.

Referring to FIGS. 5 to 7, the grounding member 300 may be formed integrally with the exterior panel 120.

The grounding member 300 may include an extension part 310, a first grounding part 360 and a second grounding part 350.

The extension part 310 may be provided to extend parallel to the exterior panel 120 from the panel body 124 of the exterior panel 120.

A side of the extension part 310 may be provided to be spaced apart from the panel body of the exterior panel 120. In other words, a space separated by a predetermined distance may be formed between the side of the extension part 310 and the panel body.

More specifically, an extension length of the extension part 310 may be provided to be longer than a thickness of the exterior panel 120.

The extension length of the extension part 310 may refer to a straight line distance from a part where the panel body 124 and the extension part 310 are connected to a part where the extension part 310 and the first grounding part 360 join.

The first grounding part 360 may be provided to extend rearward from the extension part 310.

The first grounding part 360 may be provided to pass through the grounding member passing hole 134 of the door frame 130.

The second grounding part 350 may be provided to be connected to the first grounding part 360.

The grounding member 300 may include a first bent part 330 and a second bent part 320.

The first bent part 330 may be provided at a part where the extension part 310 and the first grounding part 360 are connected. More specifically, the first bent part 330 may be provided as a part where the grounding member 300 is bent.

Therefore, the extension length of the extension part 310 described above may be defined as a straight line distance from the part where the extension part 310 and the panel body 124 are connected to the first bent part 330.

The second bent part 320 may be provided at a part where the first grounding part 360 and the second grounding part 350 are connected. FIG. 5 illustrates a state in which the second grounding part 350 is not bent with respect to the first grounding part 360, and FIG. 6 illustrates a state in which the second grounding part 350 is bent with respect to the first grounding part 360.

Therefore, as illustrated in FIG. 6, the second grounding part 350 may be provided to be bent with respect to the first grounding part 360. In other words, the second grounding part 350 may be bent substantially perpendicular to the first grounding part 360 extending horizontally with a bottom surface of the cooking chamber 11.

That is, the second grounding part 350 may be provided in a direction parallel to the door frame 130 or the rear frame 140 to be in surface contact with the rear frame 140.

The grounding member 300 may include the bending guide groove 340.

The bending guide groove 340 may be formed at the part where the first grounding part 360 and the second grounding part 350 are connected. More specifically, the bending guide groove 340 may be formed by cutting the grounding member 300 from the outside toward the inside.

The bending guide groove 340 may be formed to be cut out at a bent position of the grounding member 300. Specifically, the bending guide grooves 340 may be formed as a pair on opposite sides of the second bent part 320. Also, the bending guide grooves 340 may be formed symmetrically with respect to the center of the second bent part 320.

As the bending guide groove 340 is formed on a side of the second bent part 320 to which the first grounding part 360 and the second grounding part 350 are connected, a width of the second bent part 320 may be provided to be smaller than widths of the first grounding part 360 and the second grounding part 350.

The width may be a length in left and right directions based on cooking apparatus 1. Also, the width may be a length along a direction perpendicular to a bending direction of the grounding member 300.

When the grounding member 300 is bent in an assembly process through the configuration of the bending guide groove 340, the bending may be performed at a predetermined position.

Through this, accurate assembly of the grounding member 300 may be ensured, so that quality of a product may be secured.

As the grounding member 300 is integrally formed with the exterior panel 120, the grounding member 300 may be prevented from being omitted when the door 100 of the cooking apparatus 1 is assembled. Through this, productivity and quality of the product may be improved.

The shape of the bending guide groove 340 is not limited to that illustrated in FIGS. 5 and 6, and any shape is possible as long as it is provided as a cut-out part capable of inducing bending of the grounding member 300.

For example, the bending guide groove 340 may be provided in a U-shape, a width of which narrows as it is close to the second bent part 320. The bending guide groove 340 may also be provided in a ‘C’ shape so that a width along an extending direction of the grounding member 300 is constant.

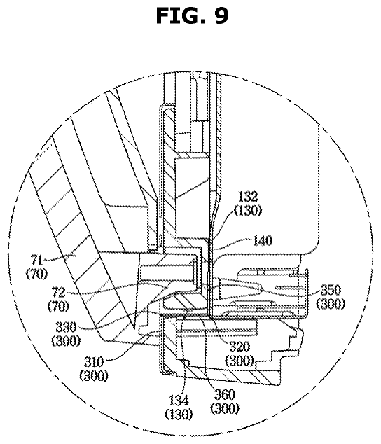

FIG. 8 is a cross-sectional view of a state in which a handle is coupled to the door of the cooking apparatus according to an embodiment of the present disclosure. FIG. 9 is an enlarged view of part B in FIG. 8.

Referring to FIG. 8, the handle 70 may be coupled to the front of the door 100 to be gripped. More specifically, the handle 70 may be coupled to the front of the exterior panel 120 to be in contact with the exterior panel 120.

The handle 70 may include the handle case 71 forming an outer appearance and the first protrusion 72 and the second protrusion 73 extending backward from the handle case 71.

The first protrusion 72 may be provided on an upper part of the handle 70, and the second protrusion 73 may be provided on a lower part of the handle 70. The handle 70 is provided to have a substantially streamlined shape, but the shape of the handle 70 is not limited thereto.

The first protrusion 72 and the second protrusion 73 may be provided in the shape of a boss. Separate fastening members may be coupled at the rear of the door 100 to be inserted into the first protrusion 72 and the second protrusion 73, respectively.

Through this, the handle 70, the exterior panel 120, the door frame 130, and the rear frame 140 may be coupled to each other.

A mutual coupling relationship between the grounding member 300, the handle 70, and the door 100 will be described below with reference to FIG. 9.

As illustrated in FIG. 9, the grounding member 300 integrally formed with the exterior panel 120 may include the extension part 310 extending from the panel body 124 of the exterior panel 120 toward the first handle coupling part 122. In other words, the extension part 310 may be disposed on the rear of the handle 70.

Therefore, when the handle 70 is mounted on the exterior panel 120, the extension part 310 of the grounding member 300 may not be exposed to the user by being covered by the handle 70.

The grounding member 300 may include the first bent part 330 and the second bent part 320.

The first bent part 330 is provided at the connection part between the extension part 310 and the first grounding part 360. The grounding member 300 may be primarily bent at the first bent part 330.

The second bent part 320 is provided at the connection part between the first grounding part 360 and the second grounding part 350. The grounding member 300 may be secondarily bent at the second bent part 320.

The grounding member 300 may be provided to pass through the grounding member passing hole 134 formed in the door frame 130.

The grounding member 300 passed through the grounding member passing hole 134 is bent in the direction parallel to the rear frame 140 so that the second bent part 320 may be disposed between the door frame 130 and the rear frame 140. Through this, the grounding member 300 may be grounded to the rear frame 140.

The first grounding part 360 of the grounding member 300 may be disposed on a side of the first handle insertion part 132 of the door frame 130. The second grounding part 350 of the grounding member 300 may be disposed at the rear of the first handle insertion part 132 of the door frame 130.

The first protrusion 72 of the handle 70 may be accommodated in the first handle insertion part 132 of the door frame 130. Therefore, a separate fastening member may be coupled to the first protrusion 72 of the handle 70 by being inserted from the rear frame 140 into the first handle insertion part 132 of the door frame 130. Through this, the handle 70 may be firmly coupled to the door 100.

However, in this case, the grounding member 300 may be pressed forward when the fastening member is coupled due to manufacturing tolerances between components in a manufacturing process of the product.

In this case, because the grounding member 300 is integrally formed with the exterior panel 120, an external force applied to the grounding member 300 may be transmitted to the exterior panel 120 as it is.

Therefore, irregularities may be unevenly generated on the exterior panel 120 exposed to the user.

However, as the grounding member 300 of the cooking apparatus 1 according to an embodiment of the present disclosure includes the extension part 310 extending by a predetermined length in a direction parallel to the exterior panel 120, an external force generated by the coupling of the fastening member from the rear may be supported by the extension part 310.

Through this, because irregularities may be formed in large numbers on the extension part 310 and the extension part 310 is covered by the handle 70 at the rear of the handle 70, the irregularities may be minimized on a front surface of the exterior panel 120 exposed to the user.

In addition, because the grounding member according to an embodiment of the present disclosure is formed integrally with the exterior panel and is bent at the second bent part, which is an accurate position, by the bending guide groove after the exterior panel and the door frame are coupled, the manufacturing process may become relatively simple.

Although the grounding member 300 according to an embodiment of the present disclosure has been illustrated and described as being formed at a lower part of the exterior panel 120, the position of the grounding member 300 is not limited thereto. Accordingly, as the formation position of the grounding member 300 is changed, a position and configuration of the counterpart may also be changed.

The foregoing has illustrated and described a specific embodiment. However, it should be understood by those of skilled in the art that the present disclosure is not limited to the above-described embodiment, and various changes and modifications may be made without departing from the technical idea of the present disclosure described in the following claims.

What is claimed is:

1. A cooking apparatus comprising:
a main body;
a cooking chamber inside the main body; and
a door in front of the main body and configured to be rotatable to open and close the cooking chamber, the door including:
a door frame,
a rear frame coupled to a rear of the door frame and configured to prevent leakage of electromagnetic waves from inside the cooking chamber through the door,
an exterior panel coupled to a front of the door frame, and
a grounding member integrally formed with the exterior panel and including a first grounding part extending rearward, a second grounding part bent from the first grounding part at a bending position and in contact with the rear frame so that the exterior panel is grounded to the rear frame, and bending guide grooves between the first grounding part and the second grounding part at the bending position.

2. The cooking apparatus according to claim 1, wherein
the exterior panel includes a panel body, and
the grounding member further includes an extension part extending parallel to the exterior panel from the panel body.

3. The cooking apparatus according to claim 2, wherein
a side of the extension part is spaced apart from the exterior panel.

4. The cooking apparatus according to claim 2, wherein
an extension length of the extension part is longer than a thickness of the exterior panel.

5. The cooking apparatus according to claim 2, wherein
the first grounding part extends rearward from the extension part and penetrates the door frame.

6. The cooking apparatus according to claim 5, wherein
the grounding member further includes:
a first bent portion, and
a second bent portion,
the extension part and the first grounding part are connected at the first bent portion, and
the first grounding part and the second grounding part are connected at the second bent portion.

7. The cooking apparatus according to claim 6, wherein the bending guide grooves are symmetrical with respect to the second bent portion.

8. The cooking apparatus according to claim 6, wherein
a width of the second bent portion is smaller than widths of the first grounding part and the second grounding part.

9. The cooking apparatus according to claim 1, further comprising:
a handle that is grippable and is at a front of the exterior panel,
wherein the handle includes a protrusion extending rearward.

10. The cooking apparatus according to claim 9, wherein
the exterior panel includes a handle coupling part through which the protrusion penetrates.

11. The cooking apparatus according to claim 10, wherein
the door frame includes:
a handle insertion portion that is recessed so that the protrusion penetrated through the handle coupling part is inserted into the handle insertion portion, and
a grounding member passing hole, and
the grounding member passes through the grounding member passing hole.

12. The cooking apparatus according to claim 11, wherein
the exterior panel includes a panel body, and
the grounding member further includes an extension part extending from the panel body toward the handle coupling part.

13. The cooking apparatus according to claim 12, wherein
the handle is mounted on the exterior panel, and
the extension part is covered by the handle.

14. The cooking apparatus according to claim 12, wherein
the first grounding part extends rearward from the extension part and passes through the grounding member passing hole, and
the second grounding part is disposed between the rear frame and the door frame.

15. The cooking apparatus according to claim 14, wherein
the first grounding part is on a side of the handle insertion portion, and
the second grounding part is on a rear of the handle insertion portion.

16. A cooking apparatus comprising:
a main body;
a cooking chamber inside the main body;
door including:
a door frame,
a rear frame,
an exterior panel, and
a grounding member integrally formed with the exterior panel and including a first grounding part, a second grounding part, and bending guide grooves at a bending position between the first grounding part and the second grounding part and configured so that the second grounding part is bendable from the first grounding part at the bending position,
wherein
the door frame, the rear frame, the exterior panel, and the grounding member are configured so that the rear frame is couplable to a rear of the door frame, the exterior panel is couplable to a front of the door frame with the first grounding part extending rearward and the second grounding part being bendable from the first grounding part at the bending position to be in contact the rear frame so that the exterior panel is grounded to the rear frame, to thereby provide the door in an assembled state configured to open and close the cooking chamber, and
with the door in the assembled state configured to open and close the cooking chamber, the rear frame is configured to prevent leakage of electromagnetic waves from inside the cooking chamber through the door.
